(19) United States
(12) Patent Application Publication
(10) Pub. No.: US 2006/0159077 A1
(43) Pub. Date: Jul. 20, 2006

(54) Service-oriented middleware for managing interoperability of heterogeneous elements of integrated systems

(76) Inventor: George Vanecek JR., Madison, WI (US)

Correspondence Address: PERKINS COIE LLP;PATENT-SEA, P.O. BOX 1247, SEATTLE, WA, 98111-1247, US

(21) Appl. No.: 11/282,307

(22) Filed: Nov. 17, 2005

Related U.S. Application Data
(63) Continuation-in-part of application No. 11/207,577, filed on Aug. 19, 2005.
(60) Provisional application No. 60/603,025, filed on Aug. 20, 2004.
(60) Provisional application No. 60/628,978, filed on Nov. 17, 2004.

(51) Int. Cl. H04L 12/50

(52) U.S. Cl. 370/360

(57) ABSTRACT

A method and system for creating integrated systems from diverse computer-based elements is provided. The integration system provides a service-oriented methodology based on a notion of services as operational abstractions to required middleware that encapsulate an element's built-in capabilities, establish a communication context with other services and client applications, and translate data to and from the native interfaces and protocols of the elements. A service is based on a service specification which defines the service's operations and the format for sending service requests to the service. The integration system is based on the existence of a distributed set of individually customized run-time environments running as service agents, which support the exchange of service specifications and the processing of service requests sent from other services and from client applications.

### CROSS-REFERENCE TO RELATED APPLICATIONS

This application claims the benefit of U.S. Provisional Patent Application No. 60/603,025 filed Aug. 20, 2004 (Attorney Docket No. 56804-8001.US00), U.S. Provisional Patent Application No. 60/628,978 filed Nov. 17, 2004 (Attorney Docket No. 56804-8001.US01), and U.S. Nonprovisional patent application Ser. No. 11/207,577 filed Aug. 19, 2005 (Attorney Docket No. 56804-8001.US02).

### BACKGROUND

Devices, hardware components, operating systems, applications, and other computer-based elements surround us and affect our lives every day. While such elements may be utilized independently, it is most often desirable to assemble a variety of such elements and their built-in capabilities into an integrated system. An integrated system may include anything from, for example, a home or office network of computers, printers, audio equipment, and other more common digital systems and devices to a complex telecommunication switching system made up of several blade servers, routers, and other devices operating cooperatively.

For several reasons, the built-in capabilities of individual elements that are to compose an integrated system are typically incapable and insufficient to collectively form the integrated system and require external systems and supporting middleware in order to realize the values of the integrated system and to allow for the system's management. First, computer-based elements each have a diverse and rich set of built-in capabilities that generally do not have standard management capabilities. Second, each element typically employs its own unique set of interfaces and protocols for realizing its built-in capabilities as well as for exposing management operations. Third, each element generally employs its own data formats, schemas, and languages to configure, manage, and control the element. Finally, the middleware developed to integrate diverse elements introduces its own set of interfaces, protocols, and data, and the elements typically have no means to absorb or interoperate with this middleware.

Several attempts have been made to standardize management of diverse elements. For example, the Simple Network Management Protocol (SNMP) was developed to facilitate the exchange of management information between network devices, such as routers. However, many elements of an integrated system may not be network devices, and using SNMP only provides an individual view into each device, rather than an integrated approach to manage a large system. Hyper-Text Markup Language (HTML) and the Hyper-Text Transfer Protocol (HTTP) provide a generic way of describing the layout and transfer of information, and while many elements may provide an HTML-based interface to view information about the element, these protocols do not provide a unified way of communicating with multiple elements or of combining the information from several elements to gain an understanding of the overall status of a system.

Therefore, it would be desirable to have a system that would allow for a standard approach to integration of diverse elements in a way that provides portability, rapid implementation, maintainability, and multiple standard interfaces for management of the system.

### BRIEF DESCRIPTION OF THE DRAWINGS

FIG. 1 illustrates a block diagram of the run-time environment of the integration system in one embodiment.

FIG. 2 is a flow diagram that illustrates the processing of the service request processor component of the integration system in one embodiment.

FIG. 3 is a flow diagram that illustrates the processing of the specification loading component in one embodiment.

FIG. 4 is a flow diagram that illustrates the processing of the adapter loading component in one embodiment.

FIG. 5 is a flow diagram that illustrates the processing of the service request processor to execute a service request in one embodiment.

FIG. 6 is a block diagram of the integration system in one embodiment.

FIG. 7 is a block diagram that illustrates a service agent of the integration system in one embodiment.

FIG. 8 is a block diagram that illustrates a composite service operation and a simple service operation in one embodiment.

FIG. 9 is a block diagram that illustrates the execution sequence of actions in one embodiment.

FIG. 10 shows an example of bootstrapping a service agent to run an HTTP server in one embodiment.

FIG. 11 is a listing of a grammar used by service specifications in one embodiment.

### DETAILED DESCRIPTION

A method and system for creating integrated systems from diverse computer-based elements is provided. The integration system provides a service-oriented methodology based on a notion of services as operational abstractions to required middleware. Services encapsulate an element's built-in capabilities, establish a communication context with other services and client applications, and translate data to and from the native interfaces and protocols of the elements. A service is based on a well-defined representation for the service's operations or functions, referred to as a service specification (XDS), which describes the format for sending request messages to the service, referred to as service requests (XSR). The XDS also describes the way in which service operations are mapped to the built-in capabilities (or primitives) of the various elements of the system. For example, imagine a typical integrated system for hosting a web site that contains several web servers, database servers, routers, and other diverse elements. One possible service in such a system is a health monitoring service that allows an administrator to view the overall health of the website and to drill-down into the health of the individual components. Such a service may include a main health monitoring service that communicates with separate web server, database, and router monitoring services, each of which can be described in a service specification.

The integration system is based on the existence of a distributed set of individually customized run-time environments, referred to as service agents, which support the exchange of service specifications and the processing of service requests sent from other services and from client applications. The run-time environments compile service specifications and translate the operations described in the service specifications to the built-in capabilities of the elements that comprise the integrated system. For example, if a router provides an SNMP interface for retrieving management information, the service specification may describe a router health monitoring service that maps a generic request for an element's health to the appropriate SNMP commands to extract the requested information from the router. Each of the components of the integration system is described in detail below.

The integration system may be employed in a variety of scenarios and frameworks. For example, it may be employed by computer programmers, system managers, and the like to perform various network management operations such as network resource discovery, systems provisioning, application configuration, and the management and monitoring of elements as required to implement the functionality of a network management system having multiple computer-based or other digital elements. The presented system may also be employed to generate embedded management applications for fixed and wireless telecommunication systems, data communication systems, network storage systems, blade server systems, etc. Overall, the system may be implemented in any suitable data processing environment, even the simplest of electronic systems capable of supporting service agents. The system can also be used in distributed computing environments as noted below, where services are performed by remote processing devices, which are linked through a communication network, such as a Local Area Network (LAN), Wide Area Network (WAN), or the Internet. In a distributed computing environment, services may be located in both local and remote memory storage devices. The system may be employed in implementing integrated systems consisting of various hardware, operating systems, middleware, and applications. Additionally, the system may also be employed to enhance the given set of the core capabilities or add missing capabilities. In general, the system may be employed wherever it is desired to form an integrated system in a flexible manner or to extend and modify such systems, without requiring extensive computer programming, compiling, debugging, testing, and redeploying of the embedded core capabilities.

In some embodiments, the integration system may be employed to rapidly and easily integrate individual elements to provide for middleware services forming the integrated system. A system may be implemented to provide a user friendly interface providing ease of use for programmers, system operators, and managers while accounting for administrative rules, policies, and processes. The system provides generalized and extensible heterogeneity of system components, interoperability between components, and changes to components and functionality in a way that simplifies reprogramming, debugging, testing, and installation, thereby reducing time and costs required to implement and modify such integrated systems.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

Service Specification

In some embodiments, service specifications for the integration system are based on Extensible Markup Language (XML). XML is a generalized representation that can encode most anything, such as programs or data, as well as serve as a universal encoding schema for transporting those programs or data. XML is conceptually a very simple but general representation that is both man and machine readable. It is also the industry standard for Internet data representations and transports. Many applications and libraries currently utilize XML for communication, configuration, logging, and information representation. The integration system can use XML to facilitate the marshalling of native data into and out of various services and to communicate that data between services. Although the use of XML as a general representation of data or programs is preferred, the integration system may be implemented using other encoding schemas and syntax.

In some embodiments, the XDS file contains a combination of a hierarchical interface (XDI) and an implementation of that interface using primitives described below. The interface defines the schema for the related class of service requests that can be given to the service described by the specification for execution. The hierarchical nature of the interface allows the capabilities and features of the related service to be organized into a hierarchical set of service operations which enables an intuitive implementation of those service operations as well as a natural ordering and nesting that hide low-level implementation details about paired operations or policies such as open/close, do/undo, obtain/release pairings typical in flat APIs. For example, the execution of related service requests can be partitioned into a nested set of pre/post action blocks that separate the classic pairing of programmatic operations. The service interface also contains all syntax definitions such as service operation names, arguments, and nesting relationships to parse and validate instances of the interface as defined by the related service requests. Knowing the interface for a particular service enables an external entity to formulate service requests specific to that service specification, thus establishing a common context between the sender of a request and the service itself. Unlike many platform layered approaches that mandate a common interface, the integration system allows each service to create its own interface. Conceptually, a given service specification defines a new context-specific language used to support a class of associated service requests.

In some embodiments, the implementation section of a service specification is a hierarchy of service operations and each has an associated set of action blocks that are executed as needed. These action blocks are written using actions that act as procedure calls and that depend on the functionality offered by the run-time environment described below. By specifying particular actions, each specification defines the set of primitives it will use and how the service operations offered by the specification are implemented using the specified primitives.

In some embodiments, the integration system provides two types of service operations for describing a hierarchy of service operations, a composite service operation and a simple service operation. A composite service operation may define a pre-action block (a list of actions to be performed before any child service operations are performed), a post-action block (a list of actions to be performed after any child service operations are performed), and an exception handling action block (a list of actions to be performed if a child operation generates an exception). A simple service operation defines only a “do” action block (a list of actions at a single level that does not reference lower-level service operations). For example, if a database containing customer records is to be abstracted by a service for updating the records, one composite service operation could be defined that updates a customer's phone number. The composite operation might include a pre-action block for logging into the database, a post-action block for logging out of the database, and an exception handling block for generating an error reply to the requestor. The composite operation could have child operations that perform the steps of finding the customer record, retrieving the old value, setting the new value, and returning a reply with the old and new values.

A depth-first ordered traversal of the service specification hierarchy as driven by the service request visits each internal operation twice, once going down, and once coming back up, and each leaf operation once. Thus, the first time a composite operation is visited, an activation record is pushed on a run-time stack along with the service operation variables as parameterized by the corresponding service request attributes, and the pre-action block in that operation is executed if it is present. Next, the child operations are processed recursively. Afterward, the post-action block is executed, and the activation record for that operation on the run-time stack is popped. For simple service operations this is identical, except that only the single do action block is executed and no children are processed. During the traversal, any action block may throw an exception which, if left unhandled, propagates up the run-time stack. The role of the composite operation's exception handler block is to selectively intercept the exceptions and handle the exceptions.

In some embodiments, the integration system provides only the XDI portion of an XDS file to a service requester. The use of service interfaces, XDIs, plays an important role in service creation and discovery. First, an XDI may be used to define the service operations of a standardized service which may then be implemented in more than one way. This service abstraction mechanism allows a common set of service requests to be sent to different services to handle different protocol and interface translations and mediation. Since each of the different services has the same interface, XDI, the service requestor can choose the appropriate service without changing the actual service requests. Second, a client application only needs the XDI in order to generate service requests, and exposing the entire service specification to the client application may be undesirable. For example, the system administrator may not want to share the implementation details of the service. Therefore, an XDI can be generated from each XDS by the service agent and released to appropriate service requesters.

In some embodiments, the service specification contains a reference to the schema for replies from the service. For example, an XML-based XDI may contain an optional attribute, xsr-reply-xds, that is the URL of an XML Schema (XSD) which defines the schema of the XSR reply. A client having the service specification for a service can use this reference to discover and interpret the format of replies coming from the service.

In some embodiments, the integration system allows a hierarchy of services to be used to build an integrated system. A particular integrated system may contain low-level services which marshal data to and from the native protocols and interfaces of managed elements, as well as higher-level services that abstract and extend these low-level services. A master service can be used to provide high-level operations, and the master service may arrange and control many lower-level services that perform the operations. In the web site example above, a master health monitoring service is able to collect data from diverse lower-level services which perform monitoring specific to a web server, a database, or other elements of the web site.

In some embodiments, the integration system allows a service to expose additional interfaces outside the service specification. Given the service-oriented nature of the integrated systems and the request-based communication between the services, the integrated system does not impose a layered interface paradigm typical of conventional systems that exhibit a front-end/back-end convention. A service may create as part of its operational capability a side-effect capability that originates a connection as part of a client or terminates a connection as part of a server to facilitate the necessary protocol mediation and translation, and these services may be utilized as either a front-end or a back-end as necessary, into or out of the integrated system. In general, an integrated system may utilize several different services to collectively expose a variety of different front-ends as needed, such as a web-based (HTTP) front-end, a command-line interface (CLI) over Telnet or SSH, a Telecom Management Protocol interface (TL1), an SNMP front-end, or a Common Information Model Object Manager (CIMOM) front-end.

In some embodiments, the integration system provides an editor for authoring service specifications. An editor can be used for authoring the XDS and extensions provided by adapters. The editor may provide an XML Schema editor, a set of available adapters, and optionally a repository of other services. The authoring steps are as follows:
1. If desired, use an XSD editor to create the XSR reply XML Schema which describes the structure of the service's XSR replies.
2. Using an XDS editor, create the XDS interface (i.e., the XDI) as a hierarchy of service operations with, their names, arguments, defaults, and descriptions.
3. If the XSR reply XSD is used, associate the XSD with the XDS.
4. Decide on the implementation details, then select and associate the required adapters with the appropriate service operations in the XDS. Typically, all adapters are declared in the root service operation.
5. Using the collective set of available actions defined by the adapters, implement the action blocks associated with the service operations.
   Run-Time Environment

The run-time environment or engine of the integration system acts as a service request processor which receives service requests, processes the requests, and, if specified by the service request, generates a reply. Each service request received by the run-time environment references a service specification that understands how the service request is to be processed. The run-time environment retrieves the compiled specified service specification based on the reference and uses it to both parse and execute the service request.

In some embodiments, the run-time environment has minimal functionality in and of itself, and is extensible by providing adapters. Adapters define the actions, or primitives, available in the run-time environment. For example, adapters may provide actions such as programmatic flow-control, exception handling, system commands, and input/output. Conceptually, these actions are environment extensions which are made available for use in service specifications to implement services. Any service operation may reference an adapter and thus extend the set of actions available to the service specification. These actions are available to all descendent service operations of the service operation where they are defined. Service specifications and their use of adapters thus dynamically reconfigure the run-time environment to define how the individual elements interoperate within the integrated system. Most programming languages are based on a well-defined syntax with a built-in set of language primitives, and programs are written against those primitives and compiled. However, the integration system is not limited to a set of a-priori defined actions, but rather provides a generalized, extensible run-time environment that allows for new primitives to be implemented through adapters. The adapters then dynamically define the language available for implementing service operations in a service specification, and enable the compilation and execution of the service specifications.

As discussed above, adapters may contain any related set of actions to support a given functionality. Typically, adapters fall into one of the following five categories, though many other categories are possible:

1. Protocol adapters, such as TCP/UDP network sockets, SNMP, or Telnet
2. Interface adapters, such as Java Database Connectivity (JDBC), Windows Management Instrumentation (WMI), or Java Native Interface (JNI) to native APIs
3. Programming language adapters, such as imperative, functional, or declarative language paradigms
4. Data structure adapters, such as arrays, dictionaries, bit strings, trees, or tables
5. Filter adapters, such as XSL translators, numeric-based conversions, or sorters

Exemplary adapters may include an SNMP stack with Management Information Base (MIB) support, a CLI server, a JDBC client, a Service Availability Forums Hardware Platform Interface (SAF/HPI), a TL1 interface, an operating system shell interface, a Common Object Request Broker Architecture Internet Inter-Orb Protocol interface (CORBA IIOP), and/or any defined application APIs or protocols, either standard or proprietary. Here is a short list of common adapters that may form a base set of useful adapters; of course, it should be understood that other and/or different adapters may be employed, depending on the particular functions to be performed:
Flow-control adapter, containing imperative actions such as a while loop, if statement, for loop, assignment statement, and procedures.
Exception adapter, containing exception handling actions such as the throw, try, catch, and the finally statements.
System adaptor, containing system related actions such as timers, properties accessors, threads, and native command execution.
File adapter, containing local file and directory actions such as ones for obtaining directory listings, file moving or deletion, and file status accessors.
XML adapter, containing actions to create, modify, inspect and export XML documents.
XSR adapter, containing actions to embed service requests inside the service specifications and execute them locally or remotely on other service agents.

In some embodiments, adapters are implemented in the Java programming language. Adapters are written against the run-time environment's internal APIs and can be developed using any target language. Using the Java language, adapters can be provided as JAR files (Java Archives). An adapter file is partitioned into five sections consisting of:
A manifest, which is a properties file describing some required details about the nature and structure of the adapter;
A set of adapter action classes used by the service specification (XDS) compiler to generate the actions code;
An optional set of channel classes used by the actions to maintain a run-time state;
An optional set of resources used by the actions such as documents or configuration files; and
Optional libraries needed by the actions. Typically, such libraries are not bundled with the adapters but kept separate for sharing with other adapters. The manifest may contain a class-path property which lists the URLs of the required libraries.

In some embodiments, adapter actions are written so that they support their own execution, parsing from the service specification (XDS) file, and printing out to a new service specification file. The total capability of the run-time environment is provided by this cooperative support from the adapter actions. For example, a Simple API for XML (SAX) based service specification compiler combines the built-in XDS parser with the incremental parsing support in each action. When a service request is received that references a particular service specification, the built-in XDS parser is used to parse common elements of the service specification, and the adapter actions are used to parse language extensions provided by the adapters that are used in the service specification. Since the adapters are dynamically loaded during the specification's compile phase, the compiler itself is extended by the self-parsing abilities of each action. The built-in XDS parser hands control to a given adapter to parse and compile its set of actions and any nested actions for structured actions from the input stream and then the adapter returns control to the XDS parser when parsing of the adapter is complete. This cooperative parsing mechanism is also used to execute the action blocks. The service request processor incrementally hands control to the right adapters which return control to the run-time environment when complete, only to be repeated until all desired action blocks have been executed.

Consider an example adapter for providing flow-control actions used by a service specification. The XDS file contains a reference to the adapter, for example, xmlns:fc=“http://localhost:6964/adapters/flowControl.jar.” The adapter provides a set of actions including an if-statement, a while-statement, an assignment-statement and a for-loop defined as follows:

<fc:if cond=”c”> . . . </fc:if>
<fc:while cod=”c”> . . . </fc:while>
<fc:set name=”x” value=”y”/>
<fc:for name=”I” from=”n” to=”m”> . . . </fc:for>

Service specifications can then use each of these flow control actions to implement service operations.

An adapter may be referenced (i.e., declared) in any service operation of a service specification as a name-space declaration attribute, for example,
<serviceop name=“NAME”xmlns:an=“AdapterURL” . . . > . . . </serviceop>

In this XML designation, “an” is a locally assigned name for the adapter and the adapter location is referred to by the attribute value as a URL (e.g., of a JAR file). Example references are:
xmlns:sys=“adapters/SystemAdapter.jar”, or
xmlns: io=“http:/Hlocalhost:6964/adapters/loAdapter.jar”.

With such definitions, any action block in this or any descendent service operation can use the actions provided by the referenced adapters. The use of an adapter's action may appear in the action blocks of a service operation as:

<an:actionName arg1=“value1” . . . argn=“valuen”>

. . .

</an:actionName>

In some embodiments, the run-time environment supports static scope rules for executing service requests in relation to arguments, variables, and procedure declarations. These are utilized by the argument declarations of the service operations and the declaration and use of variables in terms of the structured actions in order to save state information between actions.

In some embodiments, the run-time environment creates zero or more objects called channels, which the actions of an adapter use to share and exchange state information in a given XSR session. A channel is any adapter-specific object that maintains an appropriate state for the proper use of adapter actions. Action blocks may create one or more channels needed and pass them around through the session in run-time (automatic) variables. These channels are properly shut down and cleaned up when the session that created them completes. Channels may persist between sessions by being named and stored in a global channel repository persisted for the duration of an instance of the run-time environment. Other XSR sessions originating from service specifications that know about those channels may share their use, thus facilitating inter-session (i.e., inter-service request) channel sharing.

In some embodiments, the run-time environment of the integration system is multi-threaded and is able to process multiple service requests simultaneously.

In some embodiments, the run-time environment dynamically retrieves service specifications and adapters when a service request is received. When a service request arrives, the request contains a reference to the service specification on which the service request is based. The run-time environment uses this reference to dynamically retrieve the service specification, which the run-time environment then compiles. If the service specification refers to an adapter that is not available on the service agent on which the run-time environment is executing, the run-time environment can use the reference to the adapter within the service specification to dynamically retrieve the missing adapter. Once the service specification is compiled and any needed adapters have been retrieved, the run-time environment can perform the requested service operation.

In some embodiments, the run-time environment caches service specifications for use by future service requests. After processing a service request, the run-time environment does not need the service specification that the request is based on unless another service request arrives that references the same service specification. If a particular service agent repeatedly receives the same type of service requests, it is more efficient for the run-time environment to cache the compiled service specification rather than retrieve and compile the specification on each request. However, for service agents that receive many types of requests, space on the service agent may be a more important consideration, and service specifications may not be cached. Therefore, the integration system allows the caching behavior of a service agent to be configured to best suit the purpose of the service agent.

In some embodiments, the integration system enables service specifications to run on any operating system or hardware platform. The service specification is only tied to a particular platform through the choice of adapters that the service specification refers to. The run-time environment is designed to provide an abstraction layer over the underlying operating system and hardware, and may be implemented on any operating system and any hardware platform. One way the integration system may allow service specifications to run on any platform is to base the run-time and adapters on a cross-platform language, such as Java. Another way is for the run-time environment to specify the platform on which it is running when retrieving adapters referred to by the service specifications. In this way, the adapter author can provide implementations of the adapter on each platform, and provide the implementation for the particular platform requested. This allows the service specification to run without knowledge of the platform on which it is running.

In some embodiments, the integration system enables elements of the integrated system to be remotely controlled. The integration system enables client applications to use a set of logically organized services without necessarily needing to be aware of how those services are implemented or the elements that make up the integrated system. In this service-oriented methodology, integrated systems are built out of a given set of services each abstracting a required core capability or capabilities of a given element with complete freedom of whether these services are deployed as embedded services on the elements themselves or deployed remotely on cycle-servers that mediate to specific protocols remotely. Built-in capabilities on network accessible elements can be accessed by remote services through the elements' built-in protocols. Therefore, the integration system can choose how and where services are deployed. As desired by the administrator, the run-time environment may be installed either on the network element as an embedded service agent or on a proxy server to serve the role of a remote service agent.

In some embodiments, the integration system provides an HTTP interface to the run-time environment. This interface provides network access to the run-time environment from various HTTP-based applications such as a web browser or an XML-based application using an HTTP client. The HTTP service can be implemented, for example, with the use of an HTTP server adapter. The HTTP server includes a POST request handling component that extracts an encapsulated service request from an HTTP POST message and passes the request to the run-time environment. The run-time environment then executes the request. If the requested service operation generates a reply, the reply may undergo a server-side DHTML-support-using-XSL translation which accepts the resulting XML reply and generates HTML responses for the client. The HTTP service may provide other functions, such as user access authentication and secure connections using the Secure Socket Layer (SSL) protocol. The HTTP service also may form the interface for development tools to the run-time environment using protocols such as the Simple Object Access Protocol (SOAP).

In some embodiments, the integration system provides a Telnet interface to the run-time environment. A Telnet command-line interpreter (CLI) service is used to allow interactive and iterative access to service specifications from Telnet clients. The CLI allows operations driven by the service operations described in associated service specifications.

In some embodiments, the integration system provides an SNMP interface to the run-time environment. An SNMP agent service provides for control and monitoring of functions and information encoded in associated MIBs (Management Information Base) as configured and started by an appropriate SNMP service specification. An SNMP-based service specification may be designed to configure various SNMP versions (v1, v2c, or v3) for the SNMP agent and associate specialized MIBs that mediate the underlying system and component information. For example, an SNMP agent adapter may be provided with a structured action designed to register an SNMP request call-back which is invoked by the agent whenever a PDU GET request is received by the agent. The service can utilize this call-back to mediate data between the SNMP manager sending the request and the service agent on which the SNMP service is running.

Service Requests

A service request, referred to as an XSR, as received by the run-time environment, is a self-contained hierarchical message consisting of fully parameterized calls to the service operations as defined by the referenced service specification. Each service request is written with the aid of the service interface and contains a reference to the related service specification. The service interface, or XDI, is the schema that defines the syntax for the class of service requests that can be based on the referenced service specification. The reference to the service specification in the XSR can be a URL, electronic address, or other resource locator for accessing a resource on a network, or the service specification could be embedded in the service request. To execute the service request, the run-time environment provides a run-time stack and execution mechanism that holds the service request arguments, and consists of a stack of activation records for each visited entry operation in the specification. These records track the descent into the service specification as driven by the associated service request.

Service Agent

A computer-based device or element on which a run-time environment is running is called a service agent. The service agent is based on the service paradigm described here and interacts with the device's core capabilities to expose a self-describing, reconfigurable, and reactive set of services to client applications and other service agents. The service agent is typically but not necessarily configured to offer an HTTP interface over which service requests are received, service specifications and adapters are downloaded, and service interaction data is exchanged. A service agent may also be configured to expose a command-line interface over Telnet or other protocol-based interfaces as needed.

In some embodiments, the integration system provides for the discovery of service agents in an integrated system by clients that are not otherwise aware of the services available. If an address for reaching a service agent is known, an external entity can inquire and obtain the supporting set of service interfaces or just the default service interface from a given service agent by making a service request to the service to list the available services. This enables the automatic discovery of available services. Another way of discovering services is through repositories of service specifications accessible by individual service agents or manually by humans intending to understand a particular element's services.

In some embodiments, a run-time environment by itself does not provide any front-end services but needs to be bootstrapped to serve the role of a service agent. Typically this is accomplished by starting the environment with an initial service request created against an HTTP service that starts an HTTP front-end daemon. This HTTP service then accepts service requests over HTTP, executes each as described, and returns responses. The configuration of a service agent may use other front-ends besides HTTP such as a command-line interface over Telnet configured to accept service requests using CLI commands or an SNMP agent. For example, a user could send commands line-by-line over Telnet to form a service request. Many other protocols can be used alone or in combination to allow the run-time environment to be configured as a service agent.

Figures

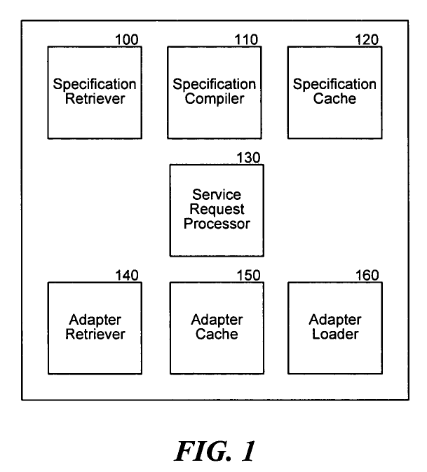

FIG. 1 illustrates a block diagram of the run-time environment of the integration system in one embodiment. The run-time environment contains a specification retriever 100, a specification compiler 110, a specification cache 120, a service request processor 130, an adapter retriever 140, an adapter cache 150, and an adapter loader 160. The specification retriever 100 retrieves service specifications referenced in service requests that are not present on the service agent on which the run-time environment is executing. The specification compiler 110 compiles service specifications in order to map service operations in a received service request to the appropriate adapter actions. The specification cache 120 stores compiled specifications for use in subsequent service requests. The service request processor 130 parses service requests, obtains the appropriate compiled specification using the specification cache 120 or specification retriever 100 and compiler 110, executes the request, and formats any reply. The adapter retriever 140 retrieves adapters that are referenced in service specifications that are not already present on the service agent. The adapter cache 150 caches previously retrieved adapters for subsequent service requests that require them. The adapter loader 160 loads retrieved adapters and integrates the primitives contained in the adapter into the run-time environment for use by service specifications.

The computing device on which the system is implemented may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

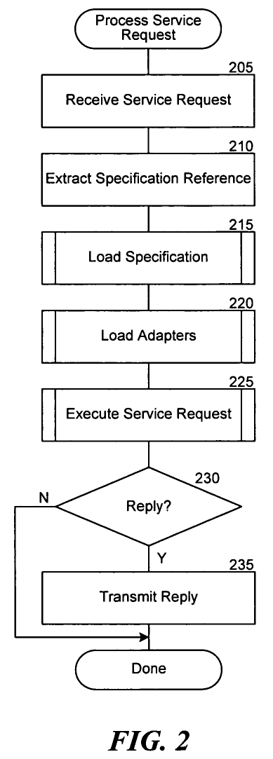

FIG. 2 is a flow diagram that illustrates the processing of the service request processor component of the integration system in one embodiment. The component is invoked when a service request is received by an instance of the run-time environment. In block 205, the component receives a service request. In block 210, the component extracts one or more service specification references from the service request. In block 215, the component loads the service specification. In block 220, the component loads any adapters referenced by the service specification. In block 225, the component executes the service request. In decision block 230, if the service request generates a reply, then the component continues to block 235, else the component completes. In block 235, the component transmits the reply to the requester. The component then completes.

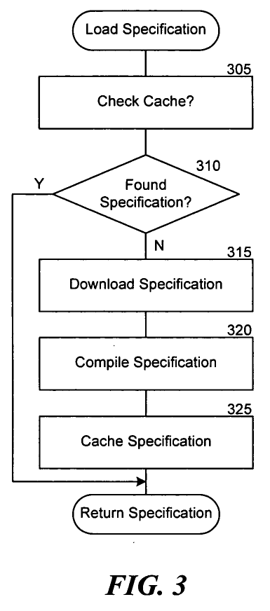

FIG. 3 is a flow diagram that illustrates the processing of the specification loading component in one embodiment. The component is comprised of the specification retriever, compiler, and cache and is invoked when a service request is received to load any service specifications referenced by the request. In block 305, the component checks the cache to determine whether the service specification has already been retrieved. The cache may contain service specifications in the form in which they were downloaded or in a pre-compiled form. In decision block 310, if the service specification was found in the cache, then the component completes, else the component continues at block 315. In block 315, the component downloads the service specification from the location described in the reference to the service specification in the service request. In block 320, the component compiles the service specification, which may include parsing the specification and resolving references to any adapters required by the specifications' defined operations. The adapters may be invoked to parse new language elements added to the run-time environment by the adapters that are referenced by the specification. In block 325, the compiled specification is added to the cache for use by future service requests. The component then completes.

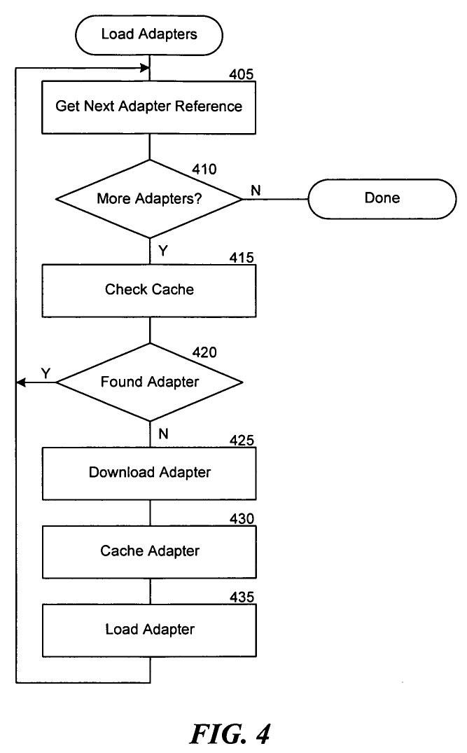

FIG. 4 is a flow diagram that illustrates the processing of the adapter loading component in one embodiment. The component is comprised of the adapter retriever, adapter cache, and adapter loader and is invoked when compiling a service request that references one or more adapters. In block 405, the component retrieves the next adapter reference from the service specification. In decision block 410, if there are no more adapters, then the component completes, else the component continues at block 415. In block 415, the component checks the adapter cache to see whether the requested adapter has already been downloaded and loaded. In decision block 420, if the adapter was found in the cache, then the component loops to block 405 and retrieves the next adapter reference, else the component continues at block 425. In block 425, the component downloads the adapter from the location described in the reference. When downloading adapters, the run-time environment may pass additional properties to the download location, such as a property identifying the platform on which the run-time environment is running, in order to retrieve an appropriate implementation of the adapter. In block 430, the component adds the retrieved adapter to the cache for future service requests. In block 435, the component loads the adapter for use by the run-time environment. The component then loops to block 405 to retrieve the next adapter reference.

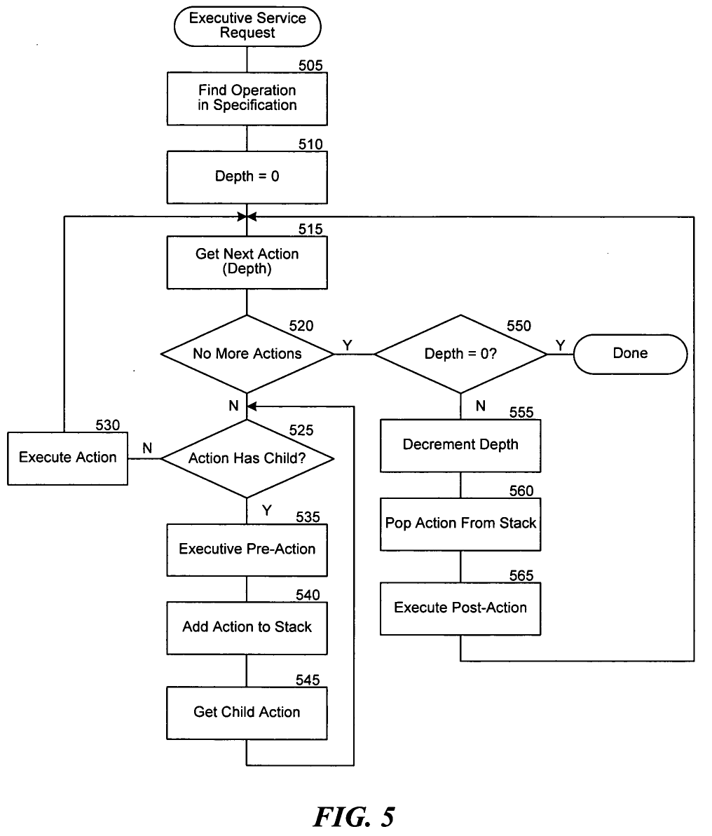

FIG. 5 is a flow diagram that illustrates the processing of the service request processor to execute a service request in one embodiment. The component is invoked to carry out the operations specified in a service request. In block 505, the component locates the requested operation in the service specification. Blocks 510-565 represent a depth-first traversal of the action tree for a requested operation, executing pre-action and post-action blocks at each level of the traversal. In block 510, the component initializes the current execution depth to zero. In block 515, the component gets the next action at the current depth that is defined for the requested operation. In decision block 520, if there are no more actions, the component continues at block 550, else the component continues at block 525. In decision block 525, if the retrieved action has no child actions, then the component continues at block 530 and executes the action, else the component continues at block 535. In block 535, the component executes any pre-action action block defined in the service specification for the retrieved action. In block 540, the component pushes the action to a stack of actions. In block 545, the component gets the first child action for the retrieved action. The component then loops to decision block 525 to determine whether the child action has children of its own.

In decision block 550, which is performed when there are no more actions at the current depth, if the current depth is zero, then the component completes, else the component continues at block 555. In block 555, the component decrements the current execution depth. In block 560, the component pops an action from the action stack. In block 565, the component executes any post-action block defined in the service specification for the retrieved action. The component then loops to block 515 to retrieve the next action at the current execution depth.

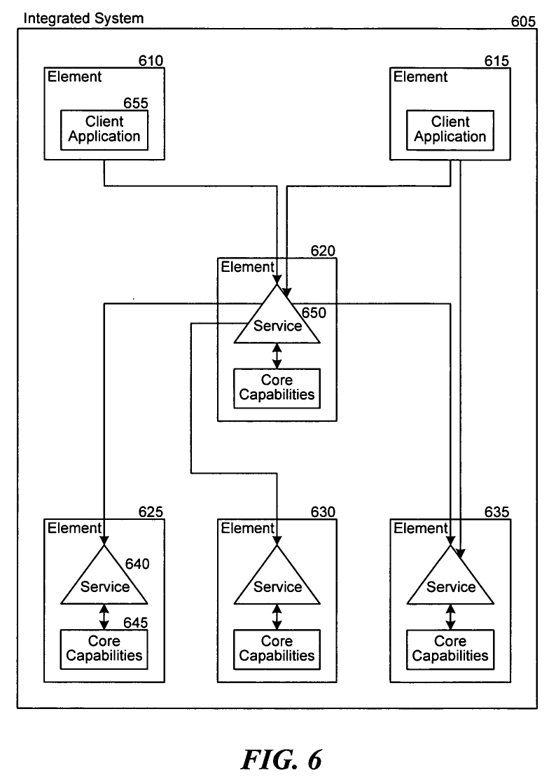

FIG. 6 is a block diagram of the integration system in one embodiment. The system 605 contains several elements 610, 615, 620, 625, 630, 635 interoperating over a network or other communication mechanism. Some elements are running client applications. For example, the element 610 is running client application 655. The client applications send service requests to one or more services. Other elements are acting as service agents, for example, elements 620, 625, 630, and 635. The element 625 contains a service agent 640 which exposes the core capabilities 645 of the element to the client application 655 as well as other services 650. A service agent need not be co-located with the element whose core capabilities it is exposing. For example, a service agent could be running on a cycle server and might connect over the network to one or more elements with core capabilities that the service exposes. Some services, such as service 650, might act as master services that communicate with several other services 640 to perform a set of service operations. Client applications can communicate with the master service or with the lower-level services directly, depending on the function that the client application is designed to perform.

One example of an integrated system that FIG. 6 could represent is a home entertainment system. The client application 655 could offer a juke box for a user to select music to listen to. The system could use a master service 650 to select among music available on various types of media. For example, the system could have a DVD changer handled by one low-level service 640 on element 625, a record changer operated by the low-level service on element 630, and a service that extracts audio from broadcast television signals on element 635. By using the service-oriented methodology of the integration system, each of the elements can be presented to a client application as a single logical view, and new elements containing additional types of media can be added without modifying the client application simply by updating the master service to be aware of a service handling a new media type.

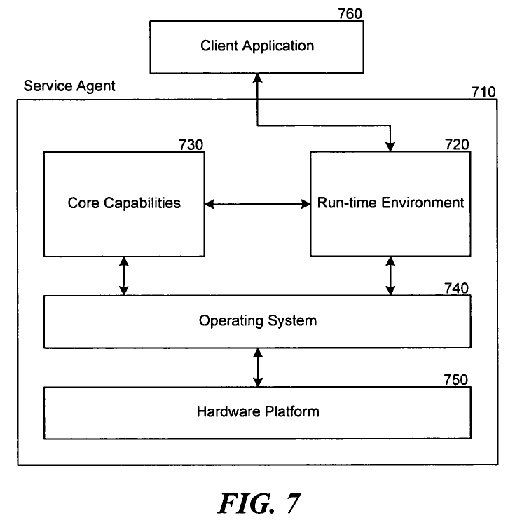

FIG. 7 is a block diagram that illustrates a service agent of the integration system in one embodiment. The service agent 710 contains a run-time environment 720, one or more core capabilities 730, an operating system 740, and a hardware platform 750. The run-time environment 720 receives service requests from client applications 760 and mediates the requests into the built-in protocols and interfaces of the core capabilities 730 of the element on which the service agent resides. The core capabilities may include hardware or software components capable of performing many different tasks as described above. The run-time environment 720 may operate on top of a virtual machine, such as a Java virtual machine, in order to make the run-time environment 720 neutral to the operating system 740 and hardware platform 750 on which it is running. Though only one service agent is shown here, there may be many service agents running on a single element performing many different tasks.

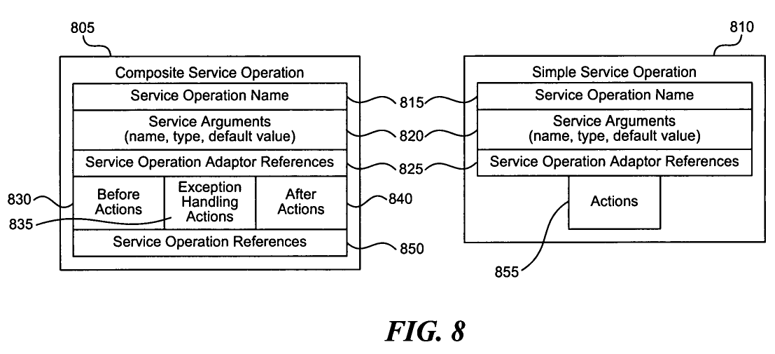

FIG. 8 is a block diagram that illustrates a composite service operation and a simple service operation in one embodiment. Both the composite service operation 805 and the simple service operation 810 contain a service operation name 815, service arguments 820, and adapter references 825. The service operation name 815 defines the name used in service requests to refer to the operation. The service arguments 820 define any required or optional arguments that can be passed in a service request to alter the behavior of the service operation. The adapter references 825 specify the location and identity of any adapters used by the service operation. The composite service operation 805 also contains pre-action blocks 830, exception handling blocks 835, post-action blocks 840, and references to child service operations 850 that are part of the composite operation 805. The pre-action blocks 830 contain actions invoked prior to calling any child actions of the composite operation 805, and the post-action blocks 840 contain actions invoked after calling all child actions of the composite operation 805. The exception handling blocks 835 contain actions invoked when a child action generates an exception that is not handled by a lower-level exception handling block. The simple service operation 810 also contains a “do” or simple action block 855 that specifies a single level of actions to be performed.

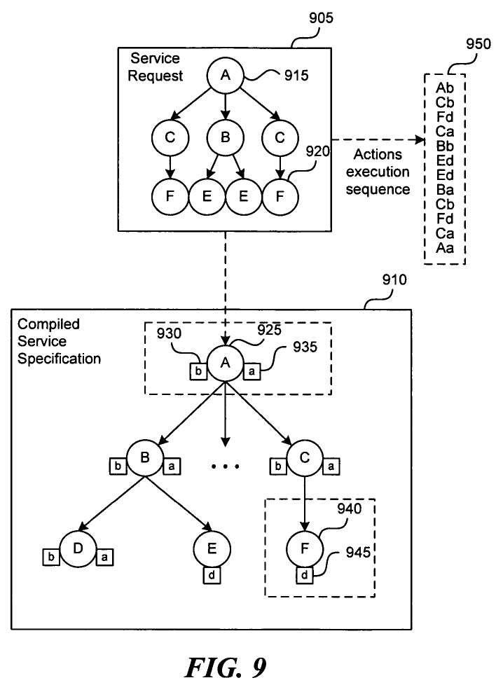

FIG. 9 is a block diagram that illustrates the execution sequence of actions in one embodiment. A service specification 910 defines several service operations A-F. Service operations at the branch nodes are composite service operations 925 that contain pre-action blocks 930 (labeled “b” for “before”) and post-action blocks 935 (labeled “a” for “after”). Service operations at the leaf nodes are simple service operations 940 that contain “do” action blocks. A service request 905 specifies operations to be performed 915 and 920. The service request 905 and specification 910 are traversed in a depth-first manner in order to produce the action execution sequence 950. As the service request 905 and specification 910 are traversed, pre-action blocks of an operation are executed before visiting any child operations of that operation, and post-action blocks are executed after all child nodes of the operation have been visited. When an operation with no child operations is visited 940, its do action block 945 is executed.

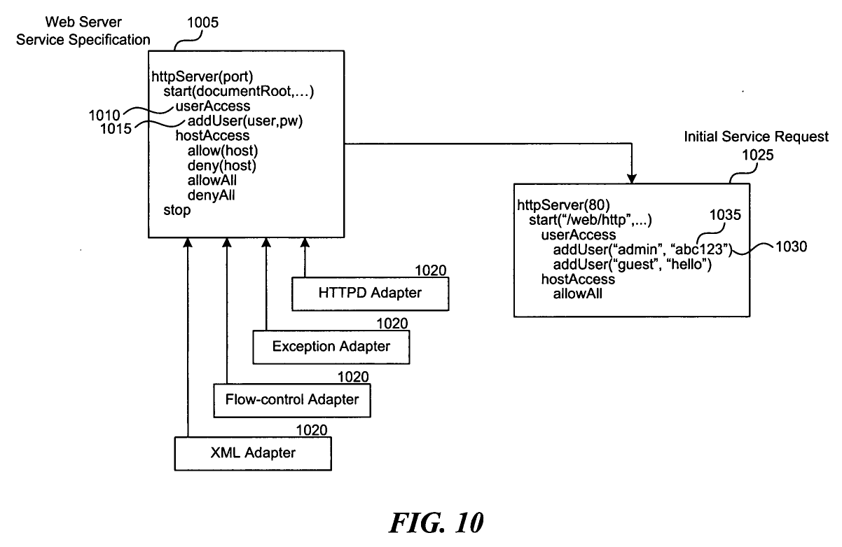

FIG. 10 shows an example of bootstrapping a service agent to run an HTTP server in one embodiment. A service request 1025 is sent to the service agent, and contains a reference to a service specification 1005. The service specification 1005 defines the operations that the service can perform. For example, the service represented by the specification 1005 has an operation for starting an HTTP server which allows for user access 1010 to be specified in the form of one or more “addUser” 1015 operations. The service request 1025 configures and starts the HTTP server according to the interface given in the specification 1005. Specifically, it starts the HTTP server on port 80 with “/web/http” as the document root directory. It also registers two user accounts having access to the web services 1030, and it allows all hosts unrestricted access. The service request 1025 contains parameters 1035 that are defined by the specific operations that are requested. Typically the run-time environment is started from a command line and is given an initial service request to configure its service and customize the environment. The HTTP server service specification 1005 implements the HTTP server using actions from four adapters 1020. The adapters 1020 support HTTP commands and replies, provide exception handling to handle any thrown exceptions, provide flow control to allow basic commands such as a conditional statement, and provide XML support to synthesize replies to service requests. Once the service agent is started by the initial service request, additional service requests can be sent to the service agent using HTTP on port 80.

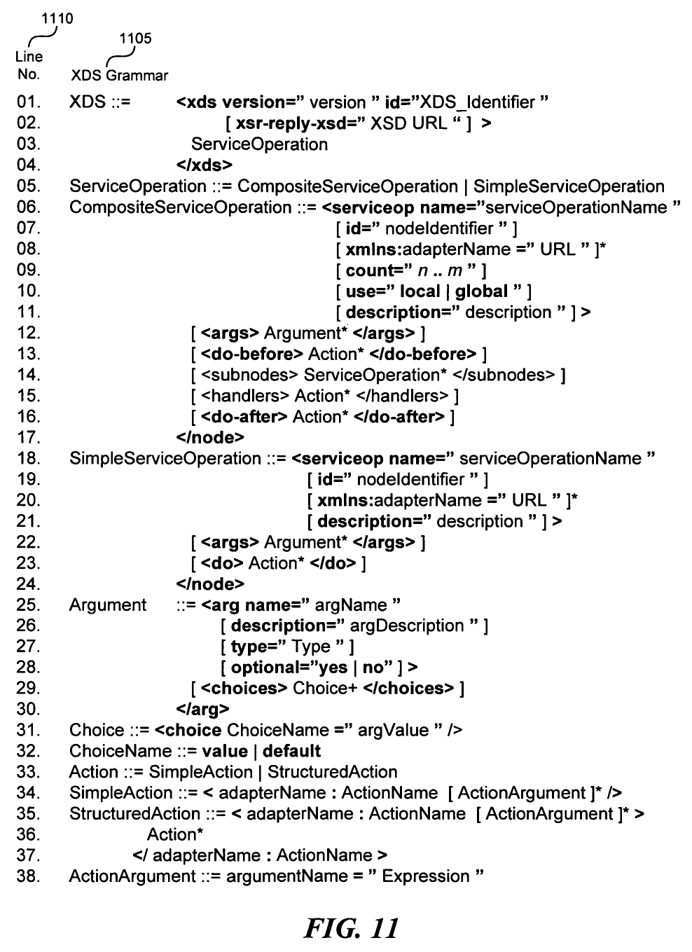

FIG. 11 is a listing of a grammar used by service specifications in one embodiment. Service specifications are based on a meta-language, named XDL, which may use XML to define service specifications. The definition of an XDL-based XDS is shown in FIG. 11 by a simplified Backus-Naur Form (BNF) grammar 1105. In the grammar 1105, italicized terms represent production names and bold text represents the XML elements and attributes of an XDS. Brackets, [ ], represent optional terms, the vertical bar, |, represents alternative terms, a plus-sign, +, represents one or more terms, and an asterisk, *, represents zero or more terms. The grammar does not show every detail of XDL such as the expression syntax, service operation linking, or security-related attributes which may be employed and which will be apparent to those skilled in the relevant art based on the present description.

XDL is designed to be as simple and general as possible for the purpose of allowing a service to be described by a service specification as a combination of the service interface and its implementation. XDL provides the syntax for the service interface portion of a service specification, but not its implementation. The syntax for the implementation, lines 33 through 38, that is, the associated actions, is provided by adapters. The parsing support built into adapter actions extends the environment's XDL parser with the parsing support in the adapters in order to allow the adapters to serve as environment extensions. To the run-time environment, an adapter is a set of one or more actions (commands) used individually as environment extensions in terms of each action providing three extension capabilities: to extend the XDL parser by parsing and compiling its actions from the external XDS representation, to print itself out to the external representation's XDS, and to execute the compiled action for a given service request.

A service interface, or XDI, is defined as an XDS without an implementation, that is, with no adapter references and no actions. Specifically, an XDI is defined in the BNF grammar for an XDL without the lines 08, 13, 15, 16, 20, 23, and 33-38. From a complete XDS, an XDI is easily generated by not including adapter and implementation details. Likewise, given an XDI, a full XDS is created by associating the required set of adapters, lines 08 and 20, and implementing the do-before (line 13), the do-after (line 16), and the exception handler (line 15) sections of composite service operations, and the do sections (line 23) of simple service operations.

Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof mean any connection or coupling, either direct or indirect, between two or more elements; the coupling or connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the integration system may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

I/We claim:

1. A system for creating integrated systems from multiple heterogeneous computer-based elements, comprising:
a software architecture based on functions or services configured as operational abstractions to required middleware, wherein the services:
encapsulate built-in capabilities of a given computer-based element,
establish a communication context with other services and client applications, and
translate data to and from native interfaces and protocols of the multiple heterogeneous computer-based elements;
a predefined service specification for available operations of each service, wherein each service specification describes a format for sending request messages to access the operations of each service, wherein each service specification also describes how service operations are mapped to built-in capabilities of the multiple heterogeneous computer-based elements;
a distributed set of individually customizable run-time environments which support the exchange of service specifications and the processing of service requests sent from other services and from client applications, wherein the run-time environments compile service specifications and translate the operations described in the service specifications to the built-in capabilities of the multiple heterogeneous computer-based elements;
wherein the system is configured to be employed in a variety of scenarios and frameworks, without requiring extensive computer programming, compiling, debugging, testing, and redeploying of embedded core capabilities, to thereby implement functionality of a network management system having multiple computer-based elements and to generate embedded management applications in data processing environments to implement integrated systems consisting of various hardware, operating systems, middleware, and applications, or to enhance a given set of core capabilities or add missing capabilities to form an integrated system in a flexible manner, or to extend and modify such systems.

2. An integrated system for managing computer-based elements, comprising:
at least one service specification component for describing one or more service operations of a service, wherein the service specification permits access to one or more actions using meta-language primitives;
at least one run-time environment component for receiving service requests, reading service specifications, and invoking adapters to perform requests; and
one or more adapter components that provide the primitives of the meta-language and perform translation and mediation of the one or more actions to the built-in capabilities of the computer-based elements.

3. The system of claim 2 wherein the service specification component uses XML to describe the service.

4. The system of claim 2 wherein the system contains multiple run-time environment components that define a hierarchy of services.

5. The system of claim 2 wherein the service exposes additional capabilities not described by the service specification.

6. The system of claim 2 wherein the run-time environment component supports static scope rules to maintain state information between actions.

7. The system of claim 2 wherein the run-time environment component is multi-threaded and supports the execution of multiple service requests simultaneously.

8. The system of claim 2 wherein the run-time environment component creates channels that allow an adapter to share state information in a service request session.

9. The system of claim 2 wherein the run-time environment component downloads the service specification component based on a service request.

10. The system of claim 9 wherein the run-time environment component includes a service specification cache component for storing downloaded service specifications for use by subsequent service requests.

11. The system of claim 2 wherein the service is a health monitoring service that monitors the health of an integrated system.

12. The system of claim 2 wherein the service specification component provides an SNMP interface to the service.

13. The system of claim 2 wherein the service specification component provides an HTTP interface to the service.

14. The system of claim 2 wherein the service specification component provides a command-line interface over Telnet to the service.

15. The system of claim 2 wherein the run-time environment is located on a different computer-based element than the computer-based element having the built-in capabilities for which the run-time environment receives requests and the adapters invoked by the run-time environment remotely perform requests.

16. A computer-implemented method of performing service operations at a service agent, comprising:
receiving a request to perform a service operation at a run-time engine;
accessing a service specification in a meta-language containing a mapping of the service operation to one or more meta-language primitives;
loading the service specification using one or more adapters to interpret the meta-language primitives;
invoking the service specification to perform the service request by using the one or more adapters to translate the one or more metalangauge primitives for the service operation to the built-in capabilities of a computer-based element.

17. The method of claim 16 wherein the service specification contains a hierarchy of service operations.

18. The method of claim 17 wherein invoking the service specification includes traversing the hierarchy of service operations and performing pre-action blocks for an ancestor service operation before performing the action blocks of its descendants.

19. The method of claim 17 wherein invoking the service specification includes traversing the hierarchy of service operations and performing post-action blocks for an ancestor service operation after performing the action blocks of its descendants.

20. The method of claim 16 wherein the request is in XML.

21. The method of claim 16 wherein the request is received over HTTP.

22. The method of claim 16 wherein the request is received over CLI.

23. The method of claim 16 wherein the service specification is divided into an interface portion and an implementation portion.

24. The method of claim 20 wherein only the interface portion is accessible to the author of a service request.

25. The method of claim 16 including generating a reply to the service request.

26. The method of claim 16 wherein run-time engine and adapters are implemented using the Java programming language.

27. The method of claim 16 wherein accessing a service specification includes checking a cache for the service specification, and if the service specification is not present in the cache, downloading the service specification from a repository of service specifications.

28. The method of claim 16 wherein loading the service specification includes checking a cache of adapters for adapters referenced in the service specification, and if an adapter is not present in the cache, downloading the adapter from a repository of adapters.

29. The method of claim 28 wherein downloading the adapter includes sending information about a platform on which the service agent is running to the adapter repository so that the repository can provide an adapter suitable for the platform.

30. A computer-implemented method of creating a service request in a meta-language, comprising:
enumerating available service specifications from a repository of known services that translate service operations in the meta-language to built-in capabilities of one or more computer-based elements;
selecting one or more service operations from among the available service operations to be requested in the service request; and
storing the service request in the meta-language containing a description of the selected service operations and a reference to the service specifications that define the selected service operations.

31. The method of claim 30 including editing one or more properties of the service operations and storing the edited properties in the service request.
editing one or more properties of the selected service operations
receiving an action to be exposed in a common format wherein the action includes a name, and mapping information for translating requests into calls to one or more adapters.

32. The method of claim 30 wherein enumerating available service specifications includes automatically discovering available services by querying one or more service agents and retrieving one or more interfaces for the services.

33. A computer-implemented method of exposing built-in capabilities of a computer-based element through a common meta-language, comprising:
enumerating available meta-language primitives from a repository of adapters that translate the meta-language primitives to the built-in capabilities of the computer based element; and
for each of one or more service operations,
defining an interface for the service operation;
associating adapters needed to perform the service operation with the service operation; and
storing in a service specification the service operation interface, a name for the service operation, and one or more actions that implement the service operation using the meta-language primitives of the associated adapters.

34. The method of claim 33 including for at least one of the one or more service operations, defining a schema for replies to the service operation and wherein storing the service specification includes storing a reference to the schema for replies in the service specification.

35. The method of claim 33 wherein the interface for at least one of the service operations includes arguments that modify the behavior of the service operation.

36. The method of claim 33 wherein the one or more service operations include a description.

37. The method of claim 33 wherein the actions include generating a service request to another service.

38. One or more computer memories collectively storing a data structure for describing a service, comprising:
a reference to one or more adapters that define primitives used to implement the service in a common meta-language;
a name of a service operation; and
one or more actions that implement the service operation using the primitives defined by the referenced adapters.

39. The data structure of claim 38 wherein the service operations are arranged hierarchically and the actions of each service operation are grouped into one or more of a pre-action block, a do-action block, and a post-action block.

40. The data structure of claim 39 wherein each service operation includes an exception handling block.

41. The data structure of claim 39 including a reference to a schema for replies to the service operation.

42. One or more computer memories collectively storing a data structure for requesting that a service operation be performed, comprising:
a reference to a service specification that defines the service operation to be performed;
a name of the service operation to be performed; and
one or more arguments to be passed to the service operation.

43. A system for translating server management requests in a common format to one or more native protocols, comprising:
a specification compiler for receiving a specification of a management request that contains mapping information for translating the request into user-modifiable functionality provided by one or more adapters;
a request processor for interpreting the compiled specification and invoking the one or more adapters in response to a management request; and
an adapter loading component for enumerating a list of available adapters, importing programmatic extensions from the adapters to the request processor to provide user-modifiable functionality, and exposing the adapters for use by a specification.
